(19) United States
(12) Patent Application Publication
(10) Pub. No.: US 2023/0389067 A1
(43) Pub. Date: Nov. 30, 2023

(54) RADIO COMMUNICATION APPARATUS AND RADIO COMMUNICATION SYSTEM

(71) Applicant: SHARP KABUSHIKI KAISHA, Sakai City, Osaka (JP)

(72) Inventors: ATSUSHI SHIRAKAWA, Sakai City, Osaka (JP); HIROMICHI TOMEBA, Sakai City, Osaka (JP); HIDEO NAMBA, Sakai City, Osaka (JP)

(21) Appl. No.: 18/034,055

(22) PCT Filed: Nov. 4, 2021
(86) PCT No.: PCT/JP2021/040478

§ 371 Date: Apr. 26, 2023

(30) Foreign Application Priority Data
Nov. 10, 2020 (JP) 2020-186913

(51) Int. Cl. H04W 74/04; H04W 72/04

(52) U.S. Cl. CPC H04W 74/04; H04W 72/04

(57) ABSTRACT

According to an aspect of the present invention, in a wireless LAN communication system, a primary channel to be used for uplink frame transmission is configured to be different from a primary channel to be used for downlink frame transmission, so that the frequency efficiency can be improved. In a wireless LAN communication system capable of frame transmission and/or reception using a broadband frequency such as a 320 MHz bandwidth, terminal apparatuses connected to an access point apparatus include terminals that perform power saving operations, legacy terminals, and low-spec terminals, and it is conceivable that a ratio of terminal apparatuses that perform frame transmission and/or reception using the entire bandwidth is not so high particularly in a transition stage. In this case, radio frames are concentrated particularly around the primary channel in the entire band, and a radio channel that cannot be used for frame transmission and/or reception and becomes idle is generated, resulting in decrease in frequency efficiency.

### TECHNICAL FIELD

An aspect of the present invention relates to a radio communication apparatus and a radio communication system. This application claims priority to JP 2020-186913 filed on Nov. 10, 2020, the contents of which are incorporated herein by reference.

### BACKGROUND ART

The Institute of Electrical and Electronics Engineers Inc. (IEEE) has been continuously working on updating the IEEE 802.11 specification, which is a wireless Local Area Network (LAN) standard, in order to achieve an increase in speed and frequency efficiency of wireless LAN communication. For wireless LAN, it is possible to perform radio communication using unlicensed bands that can be used without having to be approved (licensed) by countries or regions. For applications for individuals, such as for domestic use, Internet access from inside residences is wirelessly established by, for example, including wireless LAN access point functions in line termination apparatuses for connection to a Wide Area Network (WAN) line such as the Internet or connecting wireless LAN access point apparatuses to the line termination apparatuses. In other words, wireless LAN station apparatuses such as smartphones and PCs can connect to wireless LAN access point apparatuses to access the Internet.

With the standard IEEE 802.11ax being expected to be established in 2020, wireless LAN devices compliant with the specification draft and smartphones and personal computers (PCs) with the wireless LAN devices equipped therein are already on the market as products compliant with Wi-Fi 6 (trade name, a name for IEEE-802.1 lax compliant products certified by the Wi-Fi Alliance). Also, efforts for standardizing IEEE 802.11be as a successor to IEEE 802.11ax are currently underway. With the rapid distribution of wireless LAN devices, further improvement in throughput per user in environments with a high concentration of wireless LAN devices is being considered in the standardization of IEEE 802.11be.

Meanwhile, the European Telecommunications Standards Institute (ETSI) in Europe and the Federal Communications Commission (FCC) in the United States are considering enabling the 6 GHz band (5.935 to 7.125 GHz) to be used as an unlicensed band, and the same is also being considered in other countries around the world. This means that wireless LANs are expected to be able to use the 6 GHz band in addition to the 2.4 GHz and 5 GHz bands. In order to cope with the expansion of target frequencies, the Wi-Fi Alliance has established Wi-Fi 6E (trade name), which is an extended version of Wi-Fi 6, and to use the 6 GHz band.

To be precise, the 6 GHz band corresponds to the frequencies 5.935 to 7.125 GHz, newly enabling a bandwidth of about 1.2 GHz in total, that is, there is an increase of 14 channels in 80 MHz width-channel conversion or 7 channels in 160 MHz width-channel conversion. Since this makes abundant frequency resources available, increasing the maximum channel bandwidth usable by one wireless LAN communication system (equivalent to a BSS to be described later) from the 160 MHz in IEEE 802.1 lax to the double of 320 MHz is currently being considered in IEEE 802.11be (see NPL 1).

### CITATION LIST

### Non-Patent Literature

NPL 1: IEEE 802.11-20/0693-01-00be, May. 2020

### SUMMARY OF INVENTION

### Technical Problem

An access point apparatus adaptable to the 320 MHz bandwidth can constitute a wireless LAN communication system supporting frame transmission and/or reception of up to the 320 MHz bandwidth. For example, a station apparatus compliant with IEEE 802.1 lac operates in a bandwidth of either 80 MHz or 160 MHz, and a station apparatus compliant with IEEE 802.11ax operates in a bandwidth of any one of 20 MHz, 40 MHz, 80 MHz, or 160 MHz. The operation in the 20 MHz bandwidth of an IEEE 802.11ax compliant apparatus is intended to support a low power consumption performance, which is required for Internet of Things (IoT) applications, or a low-spec apparatus with a reduced manufacturing cost. An IEEE 802.11be compliant apparatus is expected to operate in any one of 20 MHz, 40 MHz, 80 MHz, 160 MHz, 240 MHz, or 320 MHz.

In particular, even in a case that an IEEE 802.11be compliant access point apparatus supporting the 320 MHz bandwidth is brought to the market and a radio communication system is constructed, it is expected that a ratio of apparatuses compliant with IEEE 802.11ax or under version is high among the station apparatuses to be connected, that is, only the 160 MHz bandwidth in the 320 MHz bandwidth is substantially used in many cases. Subsequently, IEEE 802.11be compliant station apparatuses may be brought to the market, and the ratio of the IEEE 802.11be compliant station apparatuses actually used in the market and field may also be expected to increase. However, some station apparatuses may only support up to 160 MHz or 80 MHz in order to reduce the manufacturing costs. In addition, even a station apparatus that supports the 320 MHz bandwidth may operate in a reduced bandwidth, such as 160 MHz or 80 MHz, depending on a time zone for power saving operation, and may not always continue to use the 320 MHz bandwidth. That is, even in the wireless LAN communication system operated in the 320 MHz bandwidth, actually, the 160 MHz bandwidth is frequently used, but the remaining 160 MHz bandwidth tends to become idle, and there arises a problem that the used bands (channels) are disproportionate and the frequencies cannot be effectively utilized as a whole.

### Solution to Problem

A communication apparatus and a communication method according to an aspect of the present invention for solving the aforementioned problem are as follows.
(1) Specifically, a communication apparatus according to an aspect of the present invention is a station apparatus for communicating with an access point apparatus by using a radio channel including multiple subchannels, the station apparatus including a receiver configured to receive a data frame using a first subchannel as a primary channel, and a transmitter configured to transmit a data frame using a second subchannel as a primary channel, wherein the second subchannel is different from the first subchannel.
(2) The communication apparatus according to an aspect of the present invention is described in the above (1), wherein a subchannel determined by the access point apparatus and notified on a broadcast channel is used as the second subchannel.
(3) The communication apparatus according to an aspect of the present invention is described in the above (1), wherein a subchannel determined by the station apparatus is used as the second subchannel.
(4) The communication apparatus according to an aspect of the present invention is described in the above (1), wherein a subchannel determined by the station apparatus is replaced, after approval from the access point apparatus is obtained, with a subchannel that is determined by the access point apparatus and notified on a broadcast channel, the subchannel replaced being used as the second subchannel.
(5) The communication apparatus according to an aspect of the present invention is described in the above (1), wherein, in the radio channel, the second subchannel is determined so as to be located farthest away from the first subchannel with respect to a frequency axis.
(6) The communication apparatus according to an aspect of the present invention is described in the above (1), wherein, in the radio channel, a subchannel with a low utilization is used the second subchannel.
(7) The communication apparatus according to an aspect of the present invention is described in the above (1), wherein while the access point apparatus is transmitting a data frame using the first subchannel as the primary channel, the station apparatus transmits a data frame using the second subchannel as the primary channel.
(8) The communication apparatus according to an aspect of the present invention is described in the above (1), wherein while the access point apparatus is receiving a data frame using the first subchannel as the primary channel, the station apparatus transmits a data frame using the second subchannel as the primary channel.
(9) A communication apparatus according to an aspect of the present invention is an access point apparatus for communicating with a terminal apparatus by using a radio channel including multiple subchannels, the access point apparatus including a transmitter configured to transmit a data frame using a first subchannel as a primary channel, and a receiver configured to receive a data frame using a second subchannel as a primary channel, wherein the second subchannel is different from the first subchannel.
(10) A radio communication system according to an aspect of the present invention is a radio communication system that uses a radio channel including multiple subchannels, the radio communication system including an access point apparatus and a terminal apparatus configured to communicate with the access point apparatus, wherein downlink communication using a first subchannel as a primary channel and uplink communication using a second subchannel as a primary channel are performed, and the second subchannel is different from the first subchannel.

### Advantageous Effects of Invention

According to an aspect of the present invention, in a radio communication system capable of using a frequency of a wide bandwidth, even in a case that a ratio of terminal apparatuses that do not perform radio communication using the entire bandwidth is high, it is possible to alleviate disproportion in radio channels to be used, contribute to smoothing of how frequently used the respective subchannels, and improve frequency effective utilization as a whole.

### BRIEF DESCRIPTION OF DRAWINGS

FIG. 1 is a diagram illustrating an example of a frame structure according to an aspect of the present invention.

FIG. 2 is a diagram illustrating an example of a frame structure according to an aspect of the present invention.

FIG. 3 is a diagram illustrating an example of communication according to an aspect of the present invention.

FIG. 4 is a schematic diagram illustrating examples of splitting radio resources according to an aspect of the present invention.

FIG. 5 is a diagram illustrating a configuration example of a communication system according to an aspect of the present invention.

FIG. 6 is a block diagram illustrating a configuration example of a radio communication apparatus according to an aspect of the present invention.

FIG. 7 is a block diagram illustrating a configuration example of a radio communication apparatus according to an aspect of the present invention.

FIG. 8 is a schematic diagram illustrating an example of a coding scheme according to an aspect of the present invention.

FIG. 9 is a diagram illustrating an example of a frame structure according to an aspect of the present invention.

FIG. 10 is an example of information related to an address of a frame according to an aspect of the present invention.

FIG. 11 is a diagram illustrating a frame transmission and/or reception according to an aspect of the present invention.

FIG. 12 is a diagram illustrating a frame transmission and/or reception according to an aspect of the present invention.

FIG. 13 is a diagram illustrating a frame transmission and/or reception according to an aspect of the present invention.

FIG. 14 is a diagram illustrating a frame transmission and/or reception according to an aspect of the present invention.

FIG. 15 is a diagram illustrating a frame transmission and/or reception according to an aspect of the present invention.

### DESCRIPTION OF EMBODIMENTS

A communication system according to the present embodiment includes a radio transmission apparatus (an access point apparatus or a base station apparatus that is an access point or a base station apparatus) and multiple radio reception apparatuses (station apparatuses and terminal apparatuses that are stations and terminal apparatuses). A network including the base station apparatus and terminal apparatuses is called a basic service set (BSS or a control range). The station apparatus according to the present embodiment can have functions of the access point apparatus. Similarly, the access point apparatus according to the present embodiment can have functions of the station apparatus. Therefore, in a case that a communication apparatus is simply mentioned below, the communication apparatus can indicate both the station apparatus and the access point apparatus.

The base station apparatus and the terminal apparatuses in the BSS are assumed to perform communication based on Carrier sense multiple access with collision avoidance (CSMA/CA). Although the present embodiment is intended for an infrastructure mode in which a base station apparatus performs communication with multiple terminal apparatuses, the method of the present embodiment can also be performed in an ad hoc mode in which terminal apparatuses perform communication directly with each other. In the ad hoc mode, a terminal apparatus substitutes for a base station apparatus to form a BSS. The BSS in the ad hoc mode may also be referred to as an independent basic service set (IBSS). In the following description, a terminal apparatus that forms an IBSS in the ad hoc mode can also be considered to be a base station apparatus. The method of the present embodiment can also be implemented in Wi-Fi Direct (trade name) in which terminal apparatuses directly communicate with each other. In the Wi-Fi Direct, a terminal apparatus substitutes for a base station apparatus to form a Group. In the following description, a Group owner terminal apparatus that forms a Group in the Wi-Fi Direct can also be regarded as a base station apparatus.

In an IEEE 802.11 system, each apparatus can transmit transmission frames of multiple frame types in a common frame format. Each of the transmission frames is defined as a physical (PHY) layer, a medium access control (MAC) layer, or a logical link control (LLC) layer.

A transmission frame of the PHY layer will be referred to as a physical protocol data unit (PPDU, PHY protocol data unit, or physical layer frame). The PPDU includes a physical layer header (PHY header) including header information and the like for performing signal processing in the physical layer, a physical service data unit (PSDU, PHY service data unit, or MAC layer frame) that is a data unit processed in the physical layer, and the like. The PSDU can include an aggregated MAC protocol data unit (MPDU) (A-MPDU) in which multiple MPDUs serving as retransmission units in a wireless section are aggregated.

A PHY header includes a reference signal such as a short training field (STF) used for detection, synchronization, and the like of signals, a long training field (LTF) used for obtaining channel information for demodulating data, and the like and a control signal such as a signal (SIG) including control information for demodulating data. In addition, STFs are classified into a legacy-STF (L-STF), a high throughput-STF (HT-STF), a very high throughput-STF (VHT-STF), a high efficiency-STF (HE-STF), an extremely high throughput-STF (EHT-STF), and the like in accordance with corresponding standards, and LTFs and SIGs are also similarly classified into an L-LTF, an HT-LTF, a VHT-LTF, an HE-LTF, an L-SIG, an HT-SIG, a VHT-SIG, an HE-SIG, and an EHT-SIG depending on the corresponding standards. The VHT-SIG is further classified into VHT-SIG-A1, VHT-SIG-A2, and VHT-SIG-B. Similarly, the HE-SIG is classified into HE-SIG-A1 to 4 and HE-SIG-B. In addition, on the assumption of technology update in the same standard, a universal SIGNAL (U-SIG) field including additional control information can be included.

Furthermore, the PHY header can include information for identifying a BSS of a transmission source of the transmission frame (hereinafter, also referred to as BSS identification information). The information for identifying a BSS can be, for example, a service set identifier (SSID) of the BSS or a MAC address of a base station apparatus of the BSS. In addition, the information for identifying a BSS can be a value unique to the BSS (e.g., a BSS color, etc.) other than an SSID or a MAC address.

The PPDU is modulated in accordance with the corresponding standard. In the IEEE 802.11n standard, for example, the PPDU is modulated into an orthogonal frequency division multiplexing (OFDM) signal.

An MPDU includes a MAC layer header (MAC header) including header information and the like for performing signal processing in the MAC layer, a MAC service data unit (MSDU) or a frame body that is a data unit processed in the MAC layer, and a frame check sequence (FCS) for checking whether there is an error in a frame. In addition, multiple MSDUs can be aggregated as an Aggregated MSDU (A-MSDU).

The frame types of transmission frames of the MAC layer are roughly classified into three frame types, namely a management frame for managing a connection state and the like between apparatuses, a control frame for managing a communication state between apparatuses, and a data frame including actual transmission data. Each frame type is further classified into multiple kinds of subframe types. The control frame includes a reception completion notification (Acknowledge or Ack) frame, a transmission request (Request to send or RTS) frame, a reception preparation completion (Clear to send or CTS) frame, and the like. The management frame includes a beacon frame, a probe request frame, a probe response frame, an authentication frame, a connection request (Association request) frame, a connection response (Association response) frame, and the like. The data frame includes a data frame, a polling (CF-poll) frame, and the like. Each apparatus can recognize the frame type and the subframe type of a received frame by interpreting contents of the frame control field included in the MAC header.

Note that an Ack may include a Block Ack. A Block Ack can give a reception completion notification with respect to multiple MPDUs.

The beacon frame includes a field in which an interval at which a beacon is transmitted (beacon interval) and an SSID are described. The base station apparatus can periodically broadcast a beacon frame within a BSS, and each terminal apparatus can recognize the base station apparatus in the surroundings of the terminal apparatus by receiving the beacon frame. The action of the terminal apparatus recognizing the base station apparatus based on the beacon frame broadcast from the base station apparatus will be referred to as passive scanning. On the other hand, the action of the terminal apparatus searching for the base station apparatus by broadcasting a probe request frame in the BSS will be referred to as active scanning. The base station apparatus can transmit a probe response frame in response to the probe request frame, and details described in the probe response frame are equivalent to those in the beacon frame.

A terminal apparatus recognizes a base station apparatus and performs a connection process with respect to the base station apparatus. The connection process is classified into an authentication procedure and a connection (association) procedure. A terminal apparatus transmits an authentication frame (authentication request) to a base station apparatus that the terminal apparatus desires to connect with. Once the base station apparatus receives the authentication frame, then the base station apparatus transmits, to the terminal apparatus, an authentication frame (authentication response) including a status code indicating whether authentication can be made for the terminal apparatus. The terminal apparatus can determine whether the terminal apparatus has been authenticated by the base station apparatus by interpreting the status code described in the authentication frame. Note that the base station apparatus and the terminal apparatus can exchange the authentication frame multiple times.

After the authentication procedure, the terminal apparatus transmits a connection request frame to the base station apparatus in order to perform the connection procedure. Once the base station apparatus receives the connection request frame, the base station apparatus determines whether to allow the connection to the terminal apparatus and transmits a connection response frame to notify the terminal apparatus of the intent. In the connection response frame, an association identifier (AID) for identifying the terminal apparatus is described in addition to the status code indicating whether to perform the connection process. The base station apparatus can manage multiple terminal apparatuses by configuring different AIDs for the terminal apparatuses for which the base station apparatus has allowed connection.

After the connection process is performed, the base station apparatus and the terminal apparatus perform actual data transmission. In the IEEE 802.11 system, a distributed coordination function (DCF), a point coordination function (PCF), and mechanisms in which the aforementioned mechanisms are enhanced (an enhanced distributed channel access (EDCA) or a hybrid control mechanism (hybrid coordination function (HCF)), and the like) are defined. A case that the base station apparatus transmits signals to the terminal apparatus using the DCF will be described below as an example.

In the DCF, the base station apparatus and the terminal apparatus perform carrier sensing (CS) for checking a utilization condition of a radio channel in the surroundings of the apparatuses prior to communication. For example, in a case that the base station apparatus serving as a transmitting station receives a signal of a higher level than a predefined clear channel assessment level (CCA level) on a radio channel, transmission of transmission frames on the radio channel is postponed. Hereinafter, a state in which a signal of a level that is equal to or higher than the CCA level is detected on the radio channel will be referred to as a busy (Busy) state, and a state in which a signal of a level that is equal to or higher than the CCA level is not detected will be referred to as an idle (Idle) state. In this manner, CS performed based on power of a signal actually received by each apparatus (reception power level) is called physical carrier sense (physical CS). Note that the CCA level is also called a carrier sense level (CS level) or a CCA threshold (CCAT). Note that, in a case that a signal of a level that is equal to or higher than the CCA level has been detected, the base station apparatus and the terminal apparatus start to perform an operation of demodulating at least a signal of the PHY layer.

The base station apparatus performs carrier sensing in an inter-frame space (IFS) in accordance with the type of transmission frame to be transmitted and determines whether the radio channel is in the busy state or idle state. A period in which the base station apparatus performs carrier sensing varies depending on the frame type and the subframe type of a transmission frame to be transmitted by the base station apparatus. In the IEEE 802.11 system, multiple IFSs with different periods are defined, and there are a short frame interval (Short IFS or SIFS) used for a transmission frame with the highest priority given, a polling frame interval (PCF IFS or PIFS) used for a transmission frame with a relatively high priority, a distribution control frame interval (DCF IFS or DIFS) used for a transmission frame with the lowest priority, and the like. In a case that the base station apparatus transmits a data frame with the DCF, the base station apparatus uses the DIFS.

The base station apparatus waits by DIFS and then further waits for a random backoff time to prevent frame collision. In the IEEE 802.11 system, a random backoff time called a contention window (CW) is used. CSMA/CA works with the assumption that a transmission frame transmitted by a certain transmitting station is received by a receiving station in a state in which there is no interference from other transmitting stations. Therefore, in a case that transmitting stations transmit transmission frames at the same timing, the frames collide against each other, and the receiving station cannot receive them properly. Thus, each transmitting station waits for a randomly configured time before starting transmission, and thus collision of frames can be avoided. In a case that the base station apparatus determines, through carrier sensing, that a radio channel is in the idle state, the base station apparatus starts to count down a CW, acquires a transmission right for the first time after the CW becomes zero, and can transmit the transmission frame to the terminal apparatus. Note that, in a case that the base station apparatus determines, through the carrier sensing, that the radio channel is in the busy state during the count-down of the CW, the base station apparatus stops the count-down of the CW. Thereafter, in a case that the radio channel becomes in the idle state, then the base station apparatus restarts the count-down of the remaining CW following the previous IFS.

Next, details of frame reception will be described. A terminal apparatus that is a receiving station receives a transmission frame, interprets the PHY header of the transmission frame, and demodulates the received transmission frame. Then, the terminal apparatus interprets the MAC header of the demodulated signal and thus can recognize whether the transmission frame is addressed to the terminal apparatus itself. Note that the terminal apparatus can also determine the destination of the transmission frame, based on information described in the PHY header (for example, a group identifier (Group ID or GID) described in VHT-SIG-A).

In a case that the terminal apparatus determines that the received transmission frame is addressed to the terminal apparatus and successfully demodulates the transmission frame without any error, the terminal apparatus is to transmit an ACK frame indicating the proper reception of the frame to the base station apparatus that is the transmitting station. The ACK frame is one of transmission frames with the highest priority transmitted only after a wait for the SIFS period (with no random backoff time). The base station apparatus ends the series of communication with the reception of the ACK frame transmitted from the terminal apparatus. Note that, in a case that the terminal apparatus is not able to receive the frame properly, the terminal apparatus does not transmit ACK. Thus, in a case that the ACK frame has not been received from the receiving station for a certain period (a length of SIFS+ACK frame) after the transmission of the frame, the base station apparatus considers the communication to be failed and ends the communication. In this manner, an end of a single communication operation (also called a burst) in the IEEE 802.11 system is to be determined based on whether an ACK frame is received, except for special cases such as a case of transmission of a broadcast signal such as a beacon frame, a case that fragmentation for splitting transmission data is used, or the like.

In a case that the terminal apparatus determines that the received transmission frame is not addressed to the terminal apparatus itself, the terminal apparatus configures a network allocation vector (NAV) based on the length of the transmission frame described in the PHY header or the like. The terminal apparatus does not attempt communication during the period configured in the NAV. In other words, because the terminal apparatus performs the same operation as in the case that the terminal apparatus determines the radio channel is in the busy state through physical CS for the period configured in the NAV, the communication control based on the NAV is also called virtual carrier sensing (virtual CS). The NAV is also configured by a transmission request (Request to send or RTS) frame or a reception preparation completion (Clear to send or CTS) frame, which is introduced to solve a hidden terminal problem, in addition to the case that the NAV is configured based on the information described in the PHY header.

Unlike the DCF in which each apparatus performs carrier sensing and autonomously acquires the transmission right, with respect to the PCF, a control station called a point coordinator (PC) controls the transmission right of each apparatus within a BSS. In general, a base station apparatus serves as a PC and acquires the transmission right of a terminal apparatus within a BSS.

A communication period using the PCF includes a contention-free period (CFP) and a contention period (CP). Communication is performed based on the aforementioned DCF during a CP period, and a PC controls the transmission right during a CFP period. The base station apparatus serving as a PC broadcasts a beacon frame with description of a CFP period (CFP max duration) and the like in a BSS prior to communication with a PCF. Note that the PIFS is used for transmission of the beacon frame broadcast at the time of a start of transmission by the PCF, and the beacon frame is transmitted without waiting for the CW. The terminal apparatus that has received the beacon frame configures the CFP period described in the beacon frame in a NAV. Hereinafter, the terminal apparatus can acquire the transmission right only in a case that a signal (e.g., a data frame including CF-poll) for signalling the acquisition of the transmission right transmitted by the PC is received, until the NAV elapses or a signal (e.g., a data frame including CF-end) broadcasting the end of the CFP in the BSS is received. Note that, because no packet collision occurs in the same BSS during the CFP period, each terminal apparatus does not take a random backoff time used for the DCF.

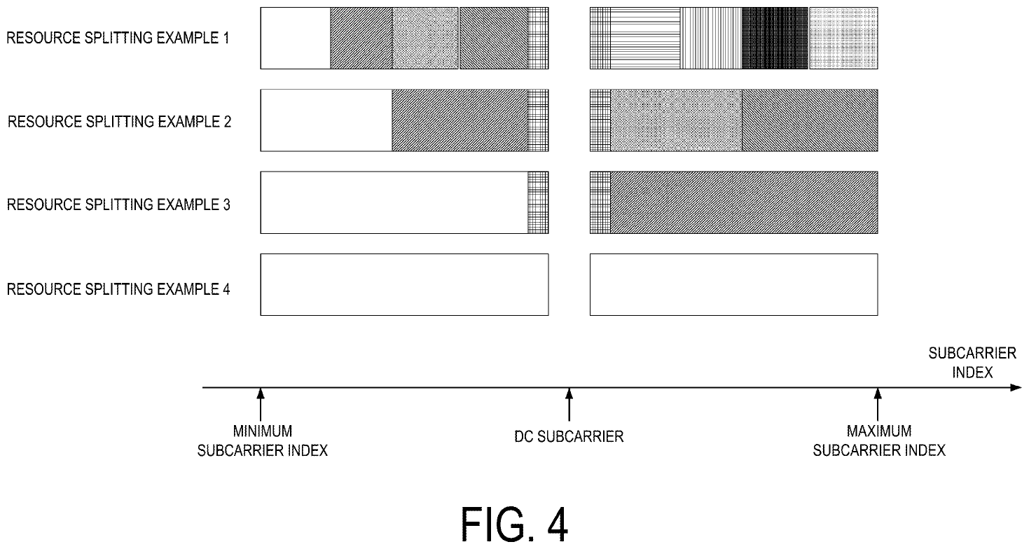

A radio medium can be split into multiple resource units (RUs). FIG. 4 is a schematic diagram illustrating an example of a split state of a radio medium. In the resource splitting example 1, for example, the radio communication apparatus can split a frequency resource (subcarrier) that is a radio medium into nine RUs. Similarly, in the resource splitting example 2, the radio communication apparatus can split a subcarrier that is a radio medium into five RUs. It is a matter of course that the resource splitting examples illustrated in FIG. 4 are merely examples, and for example, the multiple RUs can include a different number of subcarriers. The radio medium that is split into RUs can include not only a frequency resource but also a spatial resource. The radio communication apparatus (AP, for example) can transmit frames to multiple terminal apparatuses (multiple STAs, for example) at the same time by mapping each of the frames destined to different one of the multiple terminal apparatuses to the respective one of the RUs. The AP can describe information indicating the split state of the radio medium (Resource allocation information) as common control information in the PHY header of the frame transmitted by the AP. Moreover, the AP can describe information indicating an RU in which a frame addressed to each STA is mapped (resource unit assignment information) as unique control information in the PHY header of the frame transmitted by the AP itself.

Multiple terminal apparatuses (e.g., multiple STAs) can transmit frames at the same time by mapping and transmitting the frames to and in the respective RUs allocated to themselves. The multiple STAs can perform frame transmission after waiting for a prescribed period after receiving the frame including trigger information transmitted from the AP (trigger frame or TF). Each STA can recognize the RU allocated to the STA itself based on the information described in the TF. In addition, each STA can acquire the RU through random access with reference to the TF.

The AP can allocate multiple RUs to one STA at the same time. The multiple RUs can include continuous subcarriers or can include discontinuous subcarriers. The AP can transmit one frame using multiple RUs allocated to one STA or can transmit multiple frames after allocating them to different RUs. At least one of the multiple frames can be a frame including common control information for multiple terminal apparatuses that transmit resource allocation information.

One STA can be allocated multiple RUs by the AP. The STA can transmit one frame using the multiple allocated RUs. Also, the STA can use the multiple allocated RUs to transmit multiple frames allocated to different RUs. The multiple frames can be frames of different types.

The AP can allocate multiple AIDs to one STA. The AP can allocate an RU to each of the multiple AIDs allocated to the one STA. The AP can transmit different frames using the RUs allocated to the multiple AIDs allocated to the one STA. The different frames can be frames of different types.

One STA can be allocated multiple AIDs by the AP. The one STA can be allocated an RU with respect to each of the multiple allocated AIDs. The one STA recognizes all of the RUs allocated to the respective multiple AIDs allocated to the STA itself as RUs allocated to the STA and can transmit one frame using the multiple allocated RUs. In addition, the one STA can transmit multiple frames using the multiple allocated RUs. At this time, the multiple frames can be transmitted with information indicating the AIDs associated with the respective allocated RUs described therein. The AP can transmit different frames using the RUs allocated to the multiple AIDs allocated to the one STA. The different frames can be frames of different types.

Hereinafter, the base station apparatus and the terminal apparatuses may be collectively referred to as radio communication apparatuses or communication apparatuses. Information exchanged in a case that a certain radio communication apparatus performs communication with another radio communication apparatus may also be referred to as data. In other words, radio communication apparatuses include a base station apparatus and a terminal apparatus.

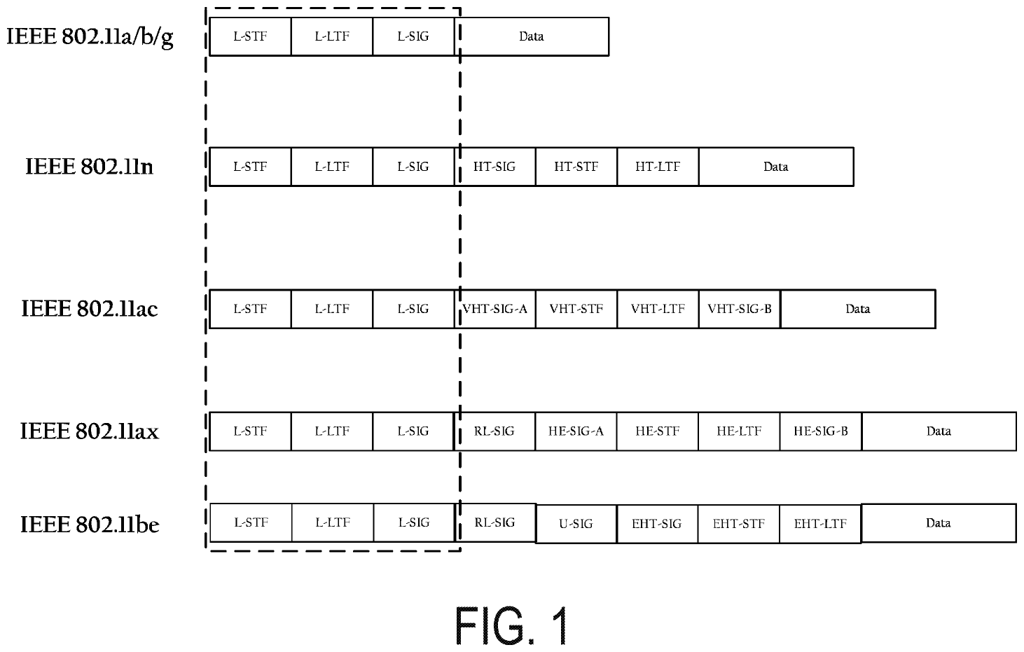

A radio communication apparatus includes any one of or both the function of transmitting a PPDU and a function of receiving a PPDU. FIG. 1 is a diagram illustrating an example of a PPDU configuration transmitted by the radio communication apparatus. A PPDU that is compliant with the IEEE 802.11a/b/g standard includes L-STF, L-LTF, L-SIG, and a Data frame (a MAC Frame, a MAC frame, a payload, a data part, data, information bits, and the like). A PPDU that is compliant with the IEEE 802.11n standard includes L-STF, L-LTF, L-SIG, HT-SIG, HT-STF, HT-LTF, and a Data frame. A PPDU that is compliant with the IEEE 802.11ac standard includes some or all of L-STF, L-LTF, L-SIG, VHT-SIG-A, VHT-STF, VHT-LTF, VHT-SIG-B, and a MAC frame. A PPDU studied in the IEEE 802.11ax standard includes some or all of L-STF, L-LTF, L-SIG, RL-SIG in which L-SIG is temporally repeated, HE-SIG-A, HE-STF, HE-LTF, HE-SIG-B, and a Data frame. A PPDU studied in the IEEE 802.11be standard includes some or all of L-STF, L-LTF, L-SIG, RL-SIG, U-SIG, EHT-SIG, EHT-STF, HET-LTF, and a Data frame.

L-STF, L-LTF, and L-SIG surrounded by the dotted line in FIG. 1 are configurations commonly used in the IEEE 802.11 standard (hereinafter, L-STF, L-LTF, and L-SIG may also be collectively referred to as an L-header). For example, a radio communication apparatus that is compliant with the IEEE 802.11a/b/g standard can appropriately receive an L-header in a PPDU that is compliant with the IEEE 802.11n/ac standard. The radio communication apparatus that is compliant with the IEEE 802.11a/b/g standard can receive the PPDU that is compliant with the IEEE 802.11n/ac standard while regarding it as a PPDU that is compliant with the IEEE 802. 11a/b/g standard.

However, because the radio communication apparatus that is compliant with the IEEE 802.11a/b/g standard cannot demodulate the PPDU that is compliant with the IEEE 802.11n/ac standard following the L-header, it is not possible to demodulate information about a transmitter address (TA), a receiver address (RA), and a Duration/ID field used for configuring a NAV.

As a method for the radio communication apparatus that is compliant with the IEEE 802.11a/b/g standard to appropriately configure a NAV (or to perform a receiving operation for a prescribed period), IEEE 802.11 defines a method of inserting Duration information to the L-SIG. Information about a transmission speed in the L-SIG (a RATE field, an L-RATE field, an L-RATE, an L_DATARATE, and an L_DATARATE field) and information about a transmission period (a LENGTH field, an L-LENGTH field, and an L-LENGTH) are used by the radio communication apparatus that is compliant with the IEEE 802.11a/b/g standard to appropriately configure a NAV.

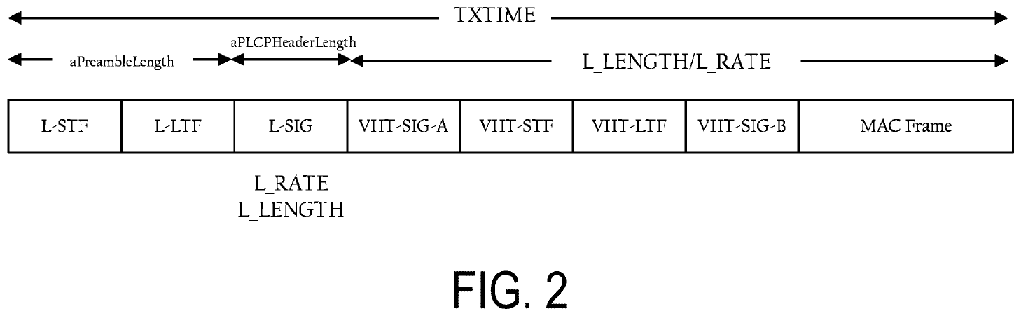

FIG. 2 is a diagram illustrating an example of a method for Duration information inserted into an L-SIG. Although a PPDU configuration that is compliant with the IEEE 802.11ac standard is illustrated as an example in FIG. 2, a PPDU configuration is not limited thereto. A PPDU configuration that is compliant with the IEEE 802.11n standard and a PPDU configuration that is compliant with the IEEE 802.11ax standard may be employed. TXTIME includes information about a length of a PPDU, aPreambleLength includes information about a length of a preamble (L-STF+L-LTF), and aPLCPHeaderLength includes information about a length of a PLCP header (L-SIG). L_LENGTH is calculated based on Signal Extension that is a virtual period configured for compatibility with the IEEE 802.11 standard, Nops related to L-RATE, aSymbolLength that is information about a period of one symbol (a symbol, an OFDM symbol, or the like), aPLCPServiceLength indicating the number of bits included in PLCP Service field, and aPLCPConvolutionalTailLength indicating the number of tail bits of a convolution code. The radio communication apparatus can calculate L_LENGTH and insert L_LENGTH into L-SIG. The radio communication apparatus can calculate L-SIG Duration. L-SIG Duration indicates information about a PPDU including L_LENGTH and information about a period that is the sum of periods of Ack and SIFS expected to be transmitted by the destination radio communication apparatus in response to the PPDU.

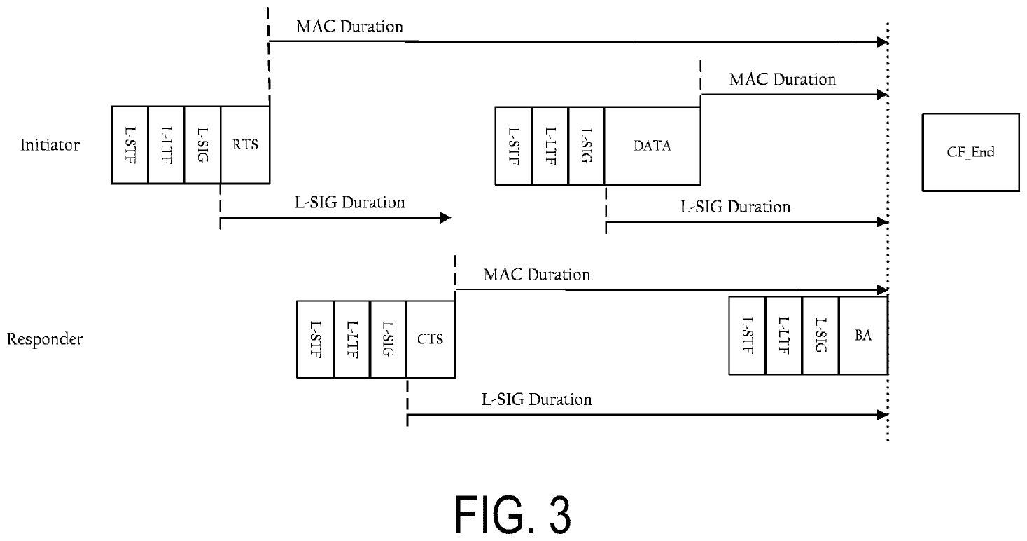

FIG. 3 is a diagram illustrating an example of L-SIG Duration in L-SIG TXOP Protection. DATA (a frame, a payload, data, and the like) include some of or both the MAC frame and the PLCP header. BA includes Block Ack or Ack. A PPDU includes L-STF, L-LTF, and L-SIG and can further include any one or more of DATA, BA, RTS, or CTS. Although L-SIG TXOP Protection using RTS/CTS is illustrated in the example illustrated in FIG. 3, CTS-to-Self may be used. Here, MAC Duration is a period indicated by a value of Duration/ID field. Initiator can transmit a CF_End frame for providing a notification regarding an end of the L-SIG TXOP Protection period.

Next, a method of identifying a BSS from a frame received by a radio communication apparatus will be described. In order for a radio communication apparatus to identify a BSS from a received frame, the radio communication apparatus that transmits a PPDU preferably inserts information for identifying the BSS (BSS color, BSS identification information, or a value unique to the BSS) into the PPDU. The information indicating the BSS color can be described in HE-SIG-A.

The radio communication apparatus can transmit L-SIG multiple times (L-SIG Repetition). For example, demodulation accuracy of L-SIG is improved by the radio communication apparatus on the reception side receiving L-SIG transmitted multiple times by using Maximum Ratio Combining (MRC). Moreover, in a case that reception of L-SIG is properly completed using MRC, the radio communication apparatus can interpret the PPDU including the L-SIG as a PPDU that is compliant with the IEEE 802.1 lax standard.

Even during the operation of receiving the PPDU, the radio communication apparatus can perform an operation of receiving part of a PPDU other than the corresponding PPDU (e.g., the preamble, L-STF, L-LTF, and the PLCP header prescribed by IEEE 802.11) (also referred to as a double-reception operation). In a case that a part of a PPDU other than the PPDU is detected during the operation of receiving the PPDU, the radio communication apparatus can update a part or an entirety of information about a destination address, a transmission source address, a PPDU, or a DATA period.

An Ack and a BA can also be referred to as a response (response frame). In addition, a probe response, an authentication response, and a connection response can also be referred to as a response.

### 1. First Embodiment

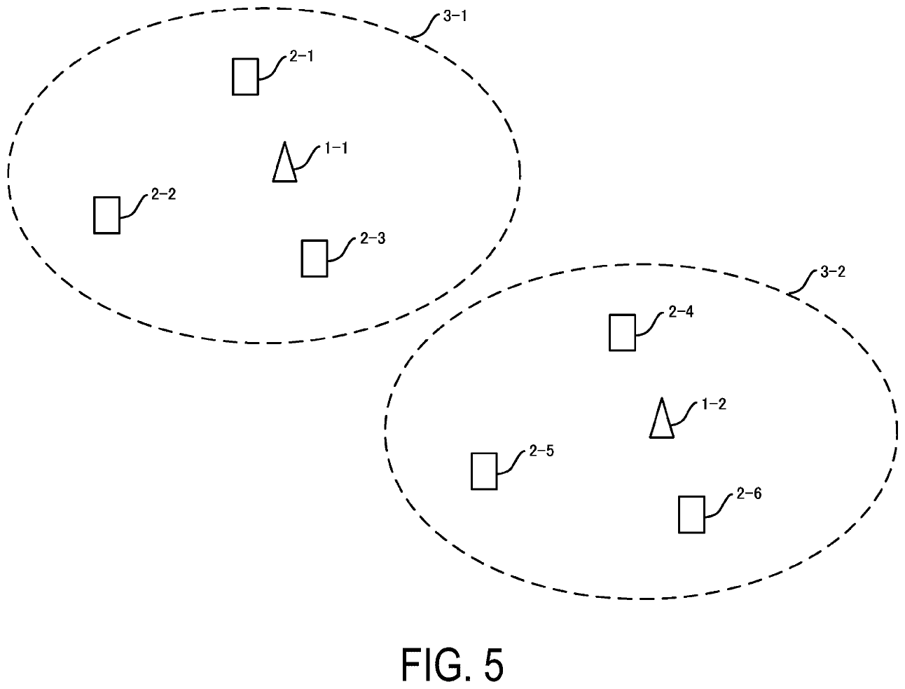

FIG. 5 is a diagram illustrating an example of a radio communication system according to the present embodiment. A radio communication system 3-1 includes a radio communication apparatus 1-1 and radio communication apparatuses 2-1 to 2-3. Note that the radio communication apparatus 1-1 may also be referred to as a base station apparatus 1-1, and the radio communication apparatuses 2-1 to 2-3 may also be referred to as terminal apparatuses 2-1 to 2-3. Each of the radio communication apparatuses 2-1 to 2-3 and each of the terminal apparatuses 2-1 to 2-3 may also be referred to as a radio communication apparatus 2A and a terminal apparatus 2A, respectively, as an apparatus connected to the radio communication apparatus 1-1. The radio communication apparatus 1-1 and the radio communication apparatus 2A are wirelessly connected and are in a state in which they can transmit and/or receive PPDUs to and from each other. The radio communication system according to the present embodiment may include a radio communication system 3-2 in addition to the radio communication system 3-1. The radio communication system 3-2 includes a radio communication apparatus 1-2 and radio communication apparatuses 2-4 to 2-6. Note that the radio communication apparatus 1-2 may also be referred to as a base station apparatus 1-2 and the radio communication apparatuses 2-4 to 2-6 may also be referred to as terminal apparatuses 2-4 to 2-6. Each of the radio communication apparatuses 2-4 to 2-6 and each of the terminal apparatuses 2-4 to 2-6 may also be referred to as a radio communication apparatus 2B and a terminal apparatus 2B, respectively, as an apparatus connected to the radio communication apparatus 1-2. Although the radio communication system 3-1 and the radio communication system 3-2 form different BSSs, this does not necessarily mean that Extended Service Sets (ESSs) are different. An ESS indicates a service set forming a local area network (LAN). In other words, radio communication apparatuses belonging to the same ESS can be regarded as belonging to the same network from a higher layer. The BSSs are connected via a Distribution System (DS) to form an ESS. Note that each of the radio communication systems 3-1 and 3-2 can further include multiple radio communication apparatuses.

In FIG. 5, it is assumed that signals transmitted by the radio communication apparatus 2A arrive at the radio transmission apparatus 1-1 and the radio communication apparatus 2B, but do not arrive at the radio communication apparatus 1-2 in the following description. In other words, in a case that the radio communication apparatus 2A transmits a signal using a certain channel, the radio communication apparatus 1-1 and the radio communication apparatus 2B determine that the channel is in the busy state, whereas the radio communication apparatus 1-2 determines that the channel is in the idle state. It is assumed that signals transmitted by the radio communication apparatus 2B arrive at the radio transmission apparatus 1-2 and the radio communication apparatus 2A, but do not arrive at the radio communication apparatus 1-1. In other words, in a case that the radio communication apparatus 2B transmits a signal using a certain channel, the radio communication apparatus 1-2 and the radio communication apparatus 2A determine that the channel is in the busy state, whereas the radio communication apparatus 1-1 determines that the channel is in the idle state.

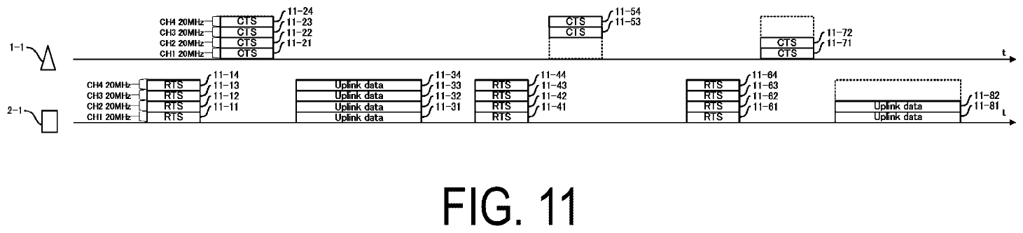

FIG. 11 is used to further describe that, in the IEEE 802.11 system, the acquisition of the transmission right is performed every 20 MHz bandwidth. For example, it is assumed that IEEE 802.11ax compliant access point apparatuses constitute a radio communication system that uses the 80 MHz bandwidth in total from a CH 1 to a CH 4 each of which is of 20 MHz bandwidth. Any one of the CH 1 to the CH 4 is configured as a primary channel, and the acquisition of the transmission right based on a backoff time count and the carrier sensing in the primary channel also affects the acquisition of the transmission right in the other channels. For example, in a case that the CH 1 is configured as the primary channel, the CH 2 adjacent to the CH 1 is referred to as a secondary channel, a combination of the CH 1 and the CH 2 is referred to as a 40 MHz Primary channel, and a combination of the CH 3 and the CH 4 adjacent to the 40 MHz Primary channel is referred to as a 40 MHz Secondary channel.

An example of a frame transmission procedure in a case that the station apparatus 2-1 transmits a frame to the access point apparatus 1-1 on the assumption that the primary channel is configured as the CH 1 will be described. The station apparatus 2-1, in a case of performing carrier sensing in the CH 1 after waiting for the random backoff time to determine that the radio channel is in the idle state, transmits an RTS frame 11-11 onto the CH 1 and transmits equivalent frames as RTS frames 11-12 to 11-14 to the CH 2 to the CH 4 at the same timing. The access point apparatus 1-1 receiving the RTS frame checks the radio channel conditions of the CH 1 to the CH 4. In a case of determining that the radio channel conditions are the idle states, the access point apparatus 1-1 transmits CTS frames 11-21 to 11-24 indicating the idle states to the CH 1 to the CH 4, respectively, and the station apparatus 2-1 receives the CTS frames 11-21 to 11-24. The station apparatus determines that the radio channels of the CH 1 to the CH 4 are available, and transmits data frames 11-31 to 11-34. Specifically, the entire channel bandwidth 80 MHz can be used for data frame transmission.

On the other hand, even in a case that the station apparatus 2-1 transmits the RTS frame, there may be a case that the CTS frame cannot be received on all of the CH 1 to the CH 4. For example, that is a case that the access point apparatus 1-1 receiving the RTS frames 11-41 to 11-44 on the CH 1 to the CH 4, respectively, checks the radio channel conditions to determine that only the CH 3 and the CH 4 are in the idle states, and transmits the CTS frames (11-53 and 11-54) only to the CH 3 and the CH 4. The station apparatus 2-1, in a case of being incapable of receiving the CTS frame on the CH 1 which is the primary channel, cannot transmit the data frames to any of the CH 1 to the CH 4. Specifically, the determination on whether to transmit the data frame depends on the condition of the primary channel.

As another example, there is a case that the CTS frame is received on the CH 1 which is the primary channel but the CTS frame cannot be received on all of the CH 1 to the CH 4. For example, that is a case that the access point apparatus receiving the RTS frames 11-61 to 11-64 on the CH 1 to the CH 4, respectively, checks the radio channel conditions to determine that only the CH 1 and the CH 2 are in the idle states, and transmits the CTS frames (11-71 and 11-72) to only the CH 1 and the CH 2. The station apparatus 2-1 is capable of data frame transmission because of having received the CTS frame on the CH 1 which is the primary channel, but recognizes that only the CH 1 and the CH 2 are in the idle states and transmits data frames 11-81 and 11-82. Specifically, only the 40 MHz bandwidth can be used in the 80 MHz bandwidth.

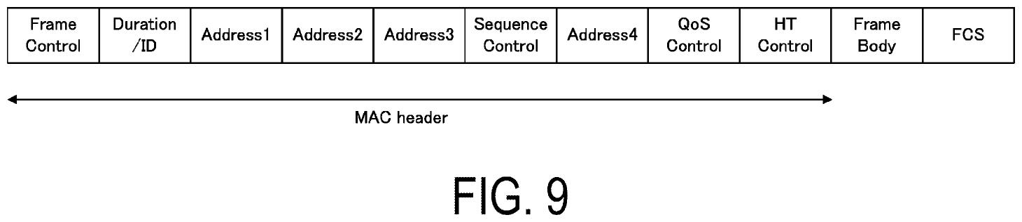

FIG. 9 illustrates an example of a MAC Frame format. The MAC Frame described herein refers to a Data frame in FIG. 1 (a MAC Frame, a MAC frame, a payload, a data part, data, an information bit, and the like) and a MAC Frame in FIG. 2. The MAC Frame includes Frame Control, Duration/ID, Address 1, Address 2, Address 3, Sequence Control, Address 4, QoS control, HT Control, Frame Body, and FCS.

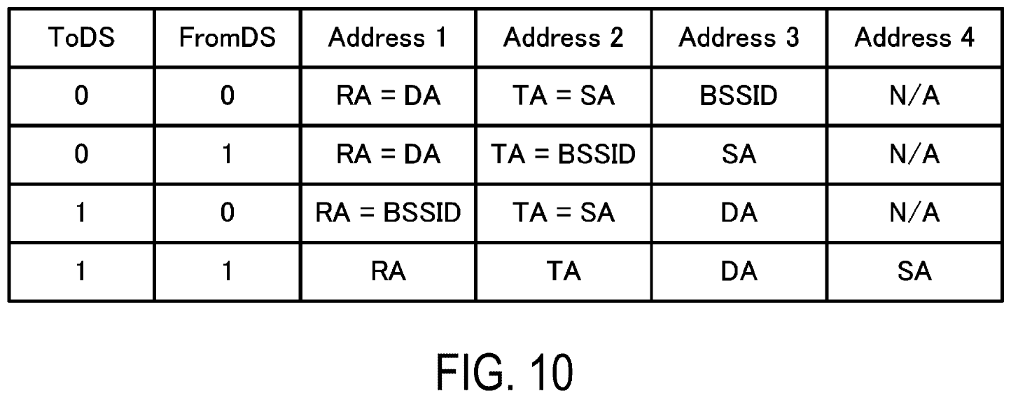

In FIG. 10, addresses written in the fields of Address 1, Address 2, Address 3, and Address 4 included in FIG. 9 are classified according to values of FromDS and ToDS and are summarized in a table. The information of FromDS and ToDS is included in the Frame Control field in FIG. 9. The value of FromDS is 1 in a case that a frame is transmitted from the DS, and 0 in a case that a frame is transmitted from a device other than the DS. The value of ToDS is 1 in a case that a frame is received by the DS, and 0 in a case that a frame is received by a device other than the DS. Note that SA indicates a Source Address (transmission source address, reference source address) and DA indicates a Destination Address (destination address, transfer destination address). The table in FIG. 10 illustrates that meanings of Address 1 to Address 4 change depending on the values of FromDS and ToDS. Note that, in a case that ToDS is 0 and FromDS is 0, Address 1 indicates “RA=DA” where “RA” connects to “DA” by “=”, which indicates that RA and DA are the same address. Also in the other combinations, the addresses connected by “=” indicate that the addresses are the same.

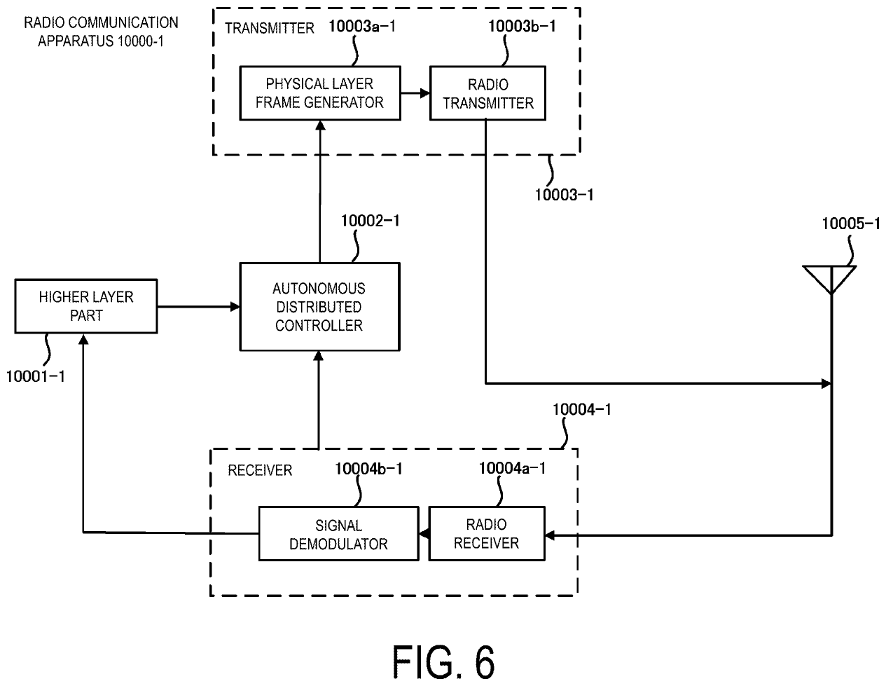

FIG. 6 is a diagram illustrating an example of an apparatus configuration of each of the radio communication apparatuses 1-1, 1-2, 2A, and 2B (hereinafter, also collectively referred to as a radio communication apparatus 10000-1). The radio communication apparatus 10000-1 includes a higher layer part (higher layer processing step) 10001-1, an autonomous distributed controller (autonomous distributed control step) 10002-1, a transmitter (transmission step) 10003-1, a receiver (reception step) 10004-1, and an antenna unit 10005-1.

The higher layer part 10001-1 is connected to another network and can notify the autonomous distributed controller 10002-1 of information about traffic. The information about traffic may be, for example, information addressed to another radio communication apparatus, or may be control information included in a management frame or a control frame.

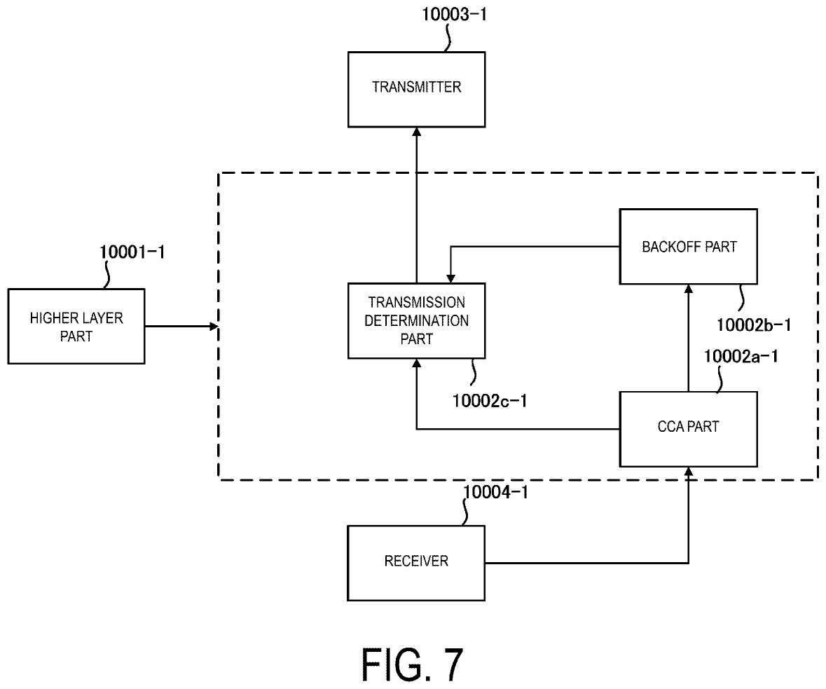

FIG. 7 is a diagram illustrating an example of an apparatus configuration of the autonomous distributed controller 10002-1. The autonomous distributed controller 10002-1 includes a CCA part (CCA step) 10002a-1, a backoff part (backoff step) 10002b-1, and a transmission determination part (transmission determination step) 10002c-1.

The CCA part 10002a-1 can use either of or both information about reception signal power received via radio resources or/and information about the reception signal (including information after decoding), which are notified of from the receiver, to determine a state of the radio resources (including determining whether the state is busy or idle). The CCA part 10002a-1 can notify the backoff part 10002b-1 and the transmission determination part 10002c-1 of the state determination information of the radio resources.

The backoff part 10002b-1 can perform backoff using the state determination information of the radio resources. The backoff part 10002b-1 has a function of generating a CW and counting down the CW. For example, count-down of the CW is performed in a case that the state determination information of the radio resources indicates idle, and the count-down of the CW can be stopped in a case that the state determination information of the radio resources indicates busy. The backoff part 10002b-1 can notify the transmission determination part 10002c-1 of the value of the CW.

The transmission determination part 10002c-1 performs transmission determination using either of or both the state determination information of the radio resources or/and the value of the CW. For example, the transmitter 10003-1 can be notified of transmission determination information in a case that the state determination information of the radio resources indicates idle and the value of the CW is zero. In addition, the transmitter 10003-1 can be notified of the transmission determination information in a case that the state determination information of the radio resources indicates idle.

The transmitter 10003-1 includes a physical layer frame generator (physical layer frame generation step) 10003a-1 and a radio transmitter (radio transmission step) 10003b-1. The physical layer frame generator 10003a-1 has a function of generating a physical layer frame (PPDU) based on the transmission determination information notified of from the transmission determination part 10002c-1. The physical layer frame generator 10003a-1 performs error correction coding, modulation, precoding filter multiplication, and the like on transmission frames sent from the higher layer. The physical layer frame generator 10003a-1 notifies the radio transmitter 10003b-1 of the generated physical layer frame.

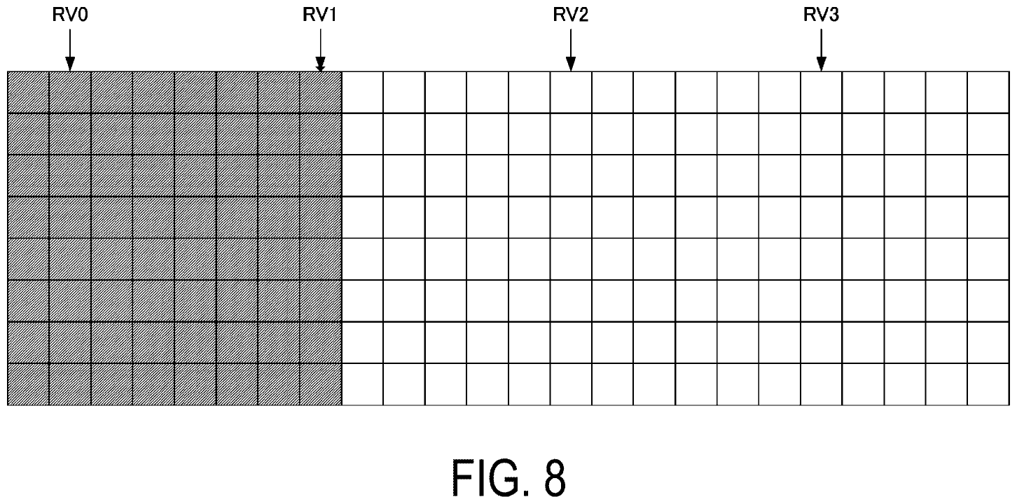

FIG. 8 is a diagram illustrating an example of error correction coding of the physical frame generator according to the present embodiment. An information bit (systematic bit) sequence is mapped in the hatching region and a redundancy (parity) bit sequence is mapped in the white region as illustrated in FIG. 8. Bit interleaving is appropriately applied to each of the information bits and the redundancy bits. The physical frame generator can read a necessary number of bits as a starting position determined for the mapped bit sequence in accordance with a value of redundancy version (RV). Flexible change in coding rate, that is puncturing, is possible by adjusting the number of bits. Note that, although a total of four RVs are illustrated in FIG. 8, the number of options for RV is not limited to a specific value in the error correction coding according to the present embodiment. Station apparatuses need to share positions of RVs.

Although the physical layer frame generator performs error correction coding on the information bits transferred from the MAC layer, a unit in which error correction coding (coding block length) is performed is not limited. For example, the physical layer frame generator can divide the information bit sequence transferred from the MAC layer into information bit sequences having a prescribed length to perform error correction coding on each of the sequences, and thus can make the sequences into multiple coding blocks. Note that dummy bits can be inserted into the information bit sequence transferred from the MAC layer in a case that coding blocks are configured.

The frame generated by the physical layer frame generator 10003a-1 includes control information. The control information includes information indicating in which RU the data addressed to each radio communication apparatus is mapped (here, the RU including both frequency resources and spatial resources). The frame generated by the physical layer frame generator 10003a-1 includes a trigger frame for indicating frame transmission to the radio communication apparatus that is a destination terminal. The trigger frame includes information indicating the RU to be used by the radio communication apparatus that has received the indication for the frame transmission to transmit the frame.

The radio transmitter 10003b-1 converts the physical layer frame generated by the physical layer frame generator 10003a-1 into a signal in a radio frequency (RF) band to generate a radio frequency signal. Processing performed by the radio transmitter 10003b-1 includes digital-to-analog conversion, filtering, frequency conversion from a baseband to an RF band, and the like.

The receiver 10004-1 includes a radio receiver (radio reception step) 10004a-1 and a signal demodulator (signal demodulation step) 10004b-1. The receiver 10004-1 generates information about reception signal power from a signal in the RF band received by the antenna unit 10005-1. The receiver 10004-1 can notify the CCA part 10002a-1 of the information about the reception signal power and the information about the reception signal.

The radio receiver 10004a-1 has a function of converting a signal in the RF band received by the antenna unit 10005-1 into a baseband signal and generating a physical layer signal (e.g., a physical layer frame). Processing performed by the radio receiver 10004a-1 includes frequency conversion processing from the RF band to the baseband, filtering, and analog-to-digital conversion.

The signal demodulator 10004b-1 has a function of demodulating a physical layer signal generated by the radio receiver 10004a-1. Processing performed by the signal demodulator 10004b-1 includes channel equalization, demapping, error correction decoding, and the like. The signal demodulator 10004b-1 can extract, from the physical layer signal, information included in the PHY header, information included in the MAC header, and information included in the transmission frame, for example. The signal demodulator 10004b-1 can notify the higher layer part 10001-1 of the extracted information. Note that the signal demodulator 10004b-1 can extract any one or all of the information included in the PHY header, the information included in the MAC header, and the information included in the transmission frame.

The antenna unit 10005-1 has a function of transmitting a radio frequency signal generated by the radio transmitter 10003b-1 into the wireless space toward a radio apparatus 0-1. The antenna unit 10005-1 has a function of receiving a radio frequency signal transmitted by the radio apparatus 0-1.

The radio communication apparatus 10000-1 can describe, in the PHY header or the MAC header of the frame to be transmitted, information indicating a period in which the radio communication apparatus 10000-1 uses the radio medium, to configure a NAV for a radio communication apparatus around the radio communication apparatus 10000-1 for the period. For example, the radio communication apparatus 10000-1 can describe the information indicating the period in the Duration/ID field or a Length field of the frame to be transmitted. The NAV period configured for the radio communication apparatuses around the radio communication apparatus 10000-1 is referred to as a TXOP period (or simply TXOP) acquired by the radio communication apparatus 10000-1. The radio communication apparatus 10000-1 that has acquired the TXOP is referred to as a TXOP holder. The type of frame to be transmitted by the radio communication apparatus 10000-1 to acquire TXOP is not limited to any frame type, and the frame may be a control frame (e.g., an RTS frame or a CTS-to-self frame) or may be a data frame.

The radio communication apparatus 10000-1 that is a TXOP holder can transmit the frame to a radio communication apparatus other than the radio communication apparatus 10000-1 itself during the TXOP. In a case that the radio communication apparatus 1-1 is a TXOP holder, the radio communication apparatus 1-1 can transmit a frame to the radio communication apparatus 2A during the TXOP period. In addition, the radio communication apparatus 1-1 can indicate, to the radio communication apparatus 2A, a frame transmission addressed to the radio communication apparatus 1-1 during the TXOP period. The radio communication apparatus 1-1 can transmit, to the radio communication apparatus 2A, a trigger frame including information for indicating a frame transmission addressed to the radio communication apparatus 1-1 during the TXOP period.

The radio communication apparatus 1-1 may acquire a TXOP for the entire communication band (e.g., operation bandwidth) in which frame transmission is likely to be performed, or may acquire a TXOP for a specific communication band (Band) such as a communication band in which frames are actually transmitted (e.g., transmission bandwidth).

The radio communication apparatus, to which the radio communication apparatus 1-1 indicates a frame transmission in the TXOP period acquired by the radio communication apparatus 1-1, is not necessarily limited to a radio communication apparatus connected to the radio communication apparatus 1-1. For example, the radio communication apparatus can indicate, to radio communication apparatuses that are not connected to the radio communication apparatus itself, a frame transmission in order to cause a radio communication apparatus around the radio communication apparatus itself to transmit a management frame such as a Reassociation frame or a control frame such as an RTS/CTS frame.

Furthermore, TXOP in EDCA that is a data transmission method different from DCF will also be described. The IEEE 802.11e standard relates to the EDCA, and defines the TXOP from the perspective of QoS (Quality of Service) assurance for various services such as video transmission or VoIP. The services are roughly classified into four access categories, namely VOice (VO), Video (VI), Best Effort (BE), and BacK ground (BK). In general, the services include VO, VI, BE, and BK in this order starting with the highest priority. Each of the access categories has parameters including CWmin as a minimum value of CW, CWmax as a maximum value, AIFS (Arbitration IFS) as a type of IFS, and TXOP limit as an upper limit value of the transmission occasion, which are configured to give a difference in the priority. For example, it is possible to perform data transmission prioritized over the other access categories by configuring a relatively small value for CWmin, CWmax, and AIFS of VO with the highest priority for the purpose of voice transmission as compared with the other access categories. For example, for the VI, where the amount of transmission data is relatively large due to video transmission, the TXOP limit can be configured to be larger, so that the transmission occasion can be longer than the other access categories. In this manner, four parameter values of each of the access categories are adjusted for the purpose of QoS assurance in accordance with various services.

In the present embodiment, the signal demodulator of the station apparatus can perform a decoding processing for the received signal, in the physical layer, and perform error detection. Here, the decoding processing includes decoding of codes that have been error-corrected which is applied to the received signal. Here, the error detection includes error detection using an error correction code (e.g., a cyclic redundancy check (CRC) code) that has been given to the received signal in advance, and error detection using an error correction code (e.g., low-density parity-check code (LDPC)) having an error detection function from the first. The decoding processing in the physical layer can be applied for each coding block.

The higher layer part transfers the result of decoding of the physical layer by the signal demodulator to the MAC layer. In the MAC layer, the signal of the MAC layer is restored from the transferred decoding result of the physical layer. Then, error detection is performed in the MAC layer, and it is determined that whether the signal of the MAC layer transmitted by the station apparatus as a transmission source of the reception frame has been properly restored.

As described above, the bandwidth usable in one radio communication system is 160 MHz in IEEE 802.11ax or earlier, but is extended to 320 MHz in IEEE 802.11be. An access point apparatus adaptable to the 320 MHz bandwidth can constitute a wireless LAN communication system supporting frame transmission and/or reception of up to the 320 MHz bandwidth. For example, a station apparatus compliant with IEEE 802.11ac uses 80 MHz, 160 MHz, or the like as the maximum bandwidth to operate to perform frame transmission and/or reception, and a station apparatus compliant with IEEE 802.11ax uses 20 MHz, 80 MHz, 160 MHz, or the like as the maximum bandwidth to operate to perform frame transmission and/or reception. An IEEE 802.11be compliant station apparatus is expected to perform the frame transmission and/or reception operation using 20 MHz, 80 MHz, 160 MHz, 240 MHz, or 320 MHz as the maximum bandwidth. Note that frame transmission from the access point apparatus to the station apparatus is referred to as downlink communication, and frame transmission from the station apparatus to the access point apparatus is referred to as uplink communication.

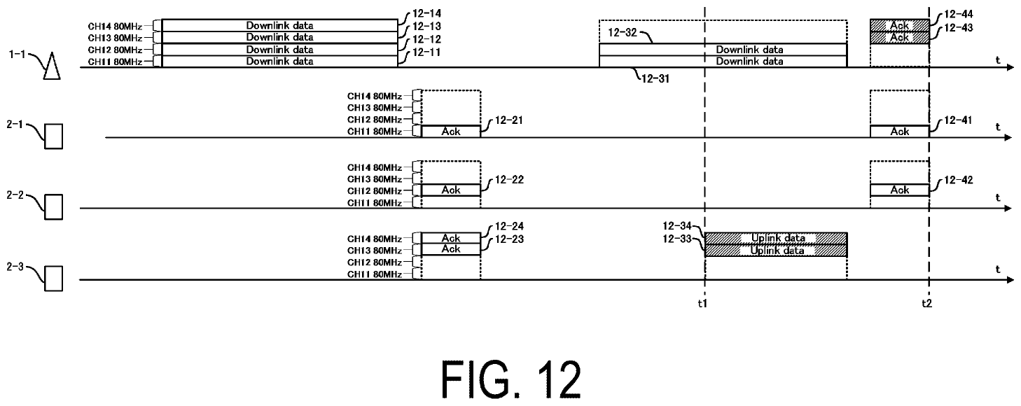

As an example, how the radio channel is used in a case that station apparatuses using different maximum bandwidths mixedly exist in a radio communication system will be described with reference to FIG. 12. FIG. 12 omits the RTS/CTS frame, which is a sequence for checking whether the radio channel is in the idle state or the busy state, and the description is given on the assumption that all channels are in the idle states and capable of frame transmission. For convenience of description, each of a CH 11 to a CH 14 is of bandwidth 80 MHz, but in practice, each of the CH 11 to the CH 14 may be handled in a subchannel unit of 20 MHz bandwidth obtained by further dividing each CH into four in order to ensure backward compatibility. That is, 16 subchannels of 20 MHz bandwidth constitute the radio communication system of 320 MHz bandwidth, and any one of the 16 subchannels is configured as the primary channel. Here, as an example, description is given on the assumption that the CH 11 is divided into four 20 MHz bandwidth subchannels, namely a CH 11-1, a CH 11-2, a CH 11-3, and a CH 11-4 in ascending order of frequencies, to be managed, and the CH 11-1 is configured as the primary channel. Similarly, the CH 12 is divided into four subchannels of a CH 12-1, a CH 12-2, a CH 12-3, and a CH 12-4 in ascending order of frequencies, the CH 13 is divided into four subchannels of a CH 13-1, a CH 13-2, a CH 13-3, and a CH 13-4 in ascending order of frequencies, and the CH 14 is divided into four subchannels of a CH 14-1, a CH 14-2, a CH 14-3, and a CH 14-4 in ascending order of frequencies, and each of the CHs is managed as a subchannel of 20 MHz bandwidth. It is assumed that station apparatuses 2-1 and 2-2 are capable of frame transmission and/or reception of up to the 160 MHz bandwidth, and thus, use the CH 11 and CH 12. It is assumed that a station apparatus 2-3 is capable of frame transmission and/or reception of up to the 320 MHz bandwidth, and thus, uses all of the CH 11 to CH 14.

Frames 12-11 to 12-14 transmitted by an access point apparatus 1-1 are examples in a case of Orthogonal Frequency Division Multiple Access (OFDMA) downlink data frame transmission using the entire 320 MHz bandwidth, and include the frame 12-11 addressed to the station apparatus 2-1, the frame 12-12 addressed to the station apparatus 2-2, and the frames 12-13 and 12-14 addressed to the station apparatus 2-3. The station apparatus 2-1 receives the frame 12-11 and transmits a response frame 12-21 to the access point apparatus 1-1. The station apparatus 2-2 receives the frame 12-12 and transmits a response frame 12-22 to the access point apparatus 1-1. The station apparatus 2-3 receives the frames 12-13 and 12-14, and transmits response frames 12-23 and 12-24 to the access point apparatus 1-1.

Frames 12-31 to 12-32 transmitted by the access point apparatus 1-1 are examples in a case of the OFDMA downlink data frame transmission using the 160 MHz bandwidth. The frames transmitted by the access point apparatus 1-1, on the assumption that there is no data addressed to the station apparatus 2-3 at that timing, includes only the frame 12-31 addressed to the station apparatus 2-1 and the frame 12-32 addressed to the station apparatus 2-2. The station apparatus 2-1 receives the frame 12-31 and transmits a response frame 12-41 to the access point apparatus 1-1. The station apparatus 2-2 receives the frame 12-32 and transmits a response frame 12-42 to the access point apparatus 1-1. There is no frame addressed to the station apparatus 2-3 supporting up to the 320 MHz bandwidth. Therefore, among the 320 MHz bandwidth, only the 160 MHz bandwidth for the CH 11 and the CH 12 are used, and the remaining 160 MHz bandwidth corresponding to the CH 13 and the CH 14 are unused and not effectively utilized. Even in a case that the station apparatus 2-3 attempts to transmit the uplink data frames 12-33 and 12-34 on the CH 13 and the CH 14, respectively, to the access point apparatus 1-1 at the time t1 in the middle of the transmission and/or reception sequence of these frames (frames 12-31 to 12-32 and frames 12-41 to 12-42), the station apparatus 2-3 cannot acquire the frame transmission right because the subchannel CH 11-1, which is the primary channel, is in the busy state. Specifically, the frames 12-33 and 12-34 cannot be transmitted. Such a result is obtained because the identical channel of the 20 MHz bandwidth (the CH 11-1 in this example) is configured as the primary channel in both the downlink communication and the uplink communication.

Therefore, in the radio communication system according to the present embodiment, a different subchannel can be configured as the primary channel in each of the downlink communication and the uplink communication. Hereinafter, the conventional primary channel is designated by Legacy Primary Channel information (LPC information), and the primary channel to be newly configured for use in the uplink communication in the present embodiment is designated by Second Primary Channel information, in order to distinguish between them. As a result, it is possible to solve the problem that, in a certain radio communication system, in a case that a common primary channel is used for both downlink communication and uplink communication, there are idle radio channels (the CH 13 and the CH 14 in the above-described example) but they cannot be used, that is, frames cannot be transmitted.

A method of using the Second Primary Channel information will be described with reference to FIG. 12. The concept of the primary channel is as in the conventional cases, and frames cannot be transmitted over the entire band as long as the corresponding radio channel is in the busy state. However, by making it possible to configure a different primary channel for each of the downlink communication and the uplink communication, the following effects can be obtained. In attempting to transmit an uplink data frame, even in a case that the primary channel designated by the Legacy Primary Channel information for downlink communication is in the busy state, in a case that the primary channel designated by the Second Primary Channel information for uplink communication is in the idle state, the station apparatus can acquire the transmission right in the radio channel in the idle state including the primary channel and transmit the frame.

A specific example will be described. In the downlink data frame transmission, as described above, it is assumed that the CH 11-1 which is the subchannel of the 20 MHz bandwidth included in the CH 11 is configure as the primary channel by the Legacy Primary Channel information. Meanwhile, in the uplink data frame transmission, it is assumed that the CH 14 is divided into the CH 14-1, the CH 14-2, the CH 14-3, and the CH 14-4, in ascending order of frequencies, which are the subchannels of the 20 MHz bandwidth, and the highest-frequency subchannel CH 14-4 is configured as the primary channel by the Second Primary Channel information. A case will be described that the station apparatus 2-3 attempts to transmit the uplink data frames 12-33 and 12-34 on the CH 13 and the CH 14, respectively, at the time t1. First, the subchannel CH 14-4 configured by the Second Primary Channel information is used as the primary channel, and the CH 13 and the CH 14 are carrier sensed. In a case that both the CH 13 and the CH 14 are determined to be in the idle states, the frames 12-33 and 12-34 can be transmitted. In accordance with the conventional primary channel concept, in a case that the CH 14 is determined to be in the idle state and the CH 13 is determined to be in the busy state, the frame 12-33 cannot be transmitted but the frame 12-34 can be transmitted. Of course, in a case that the subchannel CH 14-4 configured by the Second Primary Channel information is determined to be in the busy state, both the frames 12-33 and 12-34 cannot be transmitted.

Basically, since the access point apparatus is capable of simultaneously transmitting and receiving (Simultaneously Transmit and Receive (STR)) of frames, the station apparatus 2-3 may arbitrarily determine the transmission start time t1 of the uplink data frames without taking into account a transmission time of the downlink data frames 12-31 and 12-32. On the other hand, since the station apparatus 2-3 updates the NAVs of the CH 11 and the CH 12 by referring to the information about the TXOP stored in the preambles of the downlink data frames 12-31 and 12-32 transmitted by the access point apparatus 1-1, the station apparatus 2-3 knows that a reception end time of the response frames 12-41 and 12-42 is t2 as illustrated in FIG. 12. The transmission start time t1 of the uplink data frames 12-33 and 12-34 may be determined such that reception of the response frames 12-43 and 12-44 is completed by the time t2. The transmission start time t1 of the uplink data frames 12-33 and 12-34 may be determined such that uplink OFDMA transmission is performed in the response frames 12-41 to 12-44.

In the above-described example, in the entire 320 MHz band, the lowest-frequency subchannel CH 11-1 is used as the primary channel for downlink (configured by the Legacy Primary Channel information), and the highest-frequency subchannel CH 14-4 is used as the primary channel for uplink (configured by the Second Primary Channel information). However, the present invention is not limited to this combination, and it is possible to freely configure a combination of subchannels. The purpose is to eliminate the disproportion in how frequently used the respective subchannels (in the present example, CH 11 to CH 14, CH 11-1 to CH 11-4, CH 12-1 to CH 12-4, CH 13-1 to CH 13-4, and CH 14-1 to CH 14-4) constituting the communication band in the radio communication system. In general, subchannels around the primary channel tend to be used more frequently. It is contemplated that, in a case that another primary channel (configured by the Second Primary Channel information) is provided for uplink communication and is configured to be far from the conventionally used primary channel (configured by the Legacy Primary Channel information) on a frequency axis, the disproportion in the subchannels to be used is alleviated, contributing to smoothing of how frequently used the respective subchannels.

In the related art, the primary channel and the secondary channel used in common in downlink communication and uplink communication are notified using a High Throughput (HT) Information Element or the like included in a beacon which is a broadcast frame, and this Information Element corresponds to the above-described Legacy Primary Channel information. By broadcasting also the Second Primary Channel information by using the beacon, it is possible to notify the station apparatus connected to (Associated with) the access point apparatus. The subchannel information described in the Second Primary Channel information may be designated by an offset value in the subchannel unit of 20 MHz (or 40 MHz or 80 MHz) bandwidth from the primary channel described in the HT Information Element, or a channel number may be directly described. The offset value and the channel number may be described using a Reserve bit of an existing Information Element such as the HT Information Element, or may be described in a newly provided Information Element (Information Element dedicated to the Second Primary Channel information).

In the description of the present embodiment, the combination of the station apparatuses 2-1 and 2-2 having the maximum bandwidth of 160 MHz and the station apparatus 2-3 having the maximum bandwidth of 320 MHz has been described, but the combination of bandwidths is not limited thereto. The combination of bandwidths varies depending on the IEEE 802.11 standards with which the respective station apparatuses are compliant, for example, the station apparatus 2-1 may have the maximum bandwidth of 80 MHz, the station apparatus 2-2 may have the maximum bandwidth of 240 MHz, and the station apparatus 2-3 may have the maximum bandwidth of 360 MHz.

The problem to be solved by the present embodiment does not occur only in a radio communication system capable of using the maximum 320 MHz bandwidth. Even in a case that the maximum bandwidth is 160 MHz as in IEEE 802.11ax, the maximum bandwidth in which each station apparatus connected to the access point apparatus is capable of transmission and/or reception may be 160 MHz, 80 MHz, or 20 MHz, so various combinations may be possible. Therefore, in the case that the same primary channel is configured in both the downlink communication and the uplink communication, there arises the same problem that, even in a case that there is an unused radio channel other than the primary channel, the unused radio channel cannot be used because of the limitation that the transmission right cannot be acquired in a case of busy state of the primary channel. In the standard subsequent to IEEE 802.11be, the maximum bandwidth may be wider than 320 MHz, but the same problem may occur.

Until the previous paragraph, the procedure has been described in which the station apparatus performs carrier sensing in the primary channel notified by the Second Primary Channel information at the time of transmitting the uplink data frame to acquire the transmission right. However, the primary channel notified by the Legacy Primary Channel information may also be used for uplink data frame transmission as in the conventional cases.

Specifically, as for the transmission of the uplink data frames corresponding to 12-33 and 12-34 of the station apparatus 2-3, first, the subchannel CH 11-1 configured by the Legacy Primary Channel information is used as the primary channel to perform carrier sensing, and in a case that the CH 11 and the CH 12 are in the idle states, the frames 12-33 and 12-34 may be transmitted on the CH 11 and the CH 12, respectively. In a case that the CH 11-1 is in the busy state, the subchannel CH 14-4 notified by the Second Primary Channel information is used as the primary channel to perform carrier sensing, and in a case that the CH 13 and the CH 14 are in the idle states, the frames 12-33 and 12-34 may be transmitted on the CH 13 and the CH 14, respectively. In this manner, the subchannel configured by the Legacy Primary Channel information may be used as the primary channel for both downlink communication and uplink communication as in the conventional cases, and the subchannel notified by the Second Primary Channel information may be used as the backup primary channel.

### 2. Second Embodiment

A radio communication system, and configurations of an access point apparatus and a station apparatus in a second embodiment are similar to those in the first embodiment. In the first embodiment, the access point apparatus designates and determines a subchannel that can be used as a primary channel for uplink data frame transmission, and notifies the connected (associated) station apparatus of the subchannel as the Second Primary Channel information. In the second embodiment, the station apparatus determines the primary channel for uplink data frame transmission and requests the approval from the access point apparatus, and in a case of getting the approval, the station apparatus can use the primary channel for the uplink data frame transmission. Here, it is assumed that the primary channel determined by the station apparatus in the present embodiment is included in Third Primary Channel information.

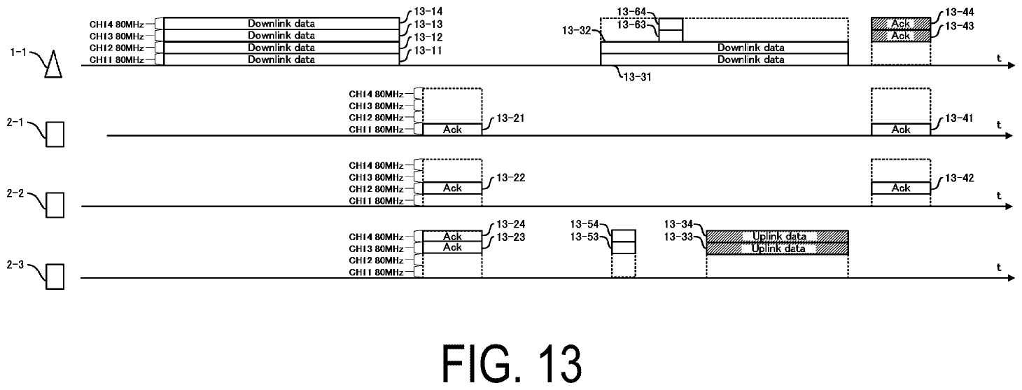

A specific procedure is described with reference to FIG. 13. As a premise, it is assumed that the subchannel CH 11-1 is configured as the primary channel by the Legacy Primary Channel information and the subchannel CH 14-4 is configured as the primary channel by the Second Primary Channel information. It is assumed that the station apparatus 2-3 determines, from the past measurement information, that both the CH 11-1 and the CH 14-4 are in the busy states with high probability, and determines that it is better to change the primary channel to the CH 13-4 with high probability of being in the idle state. In this case, the station apparatus 2-3 transmits a frame (in this example, frames 13-53 and 13-54) for requesting the access point apparatus 1-1 to change the primary channel to be used by the station apparatus 2-3 for the uplink data frame transmission to the subchannel CH 13-4 (one of the channels obtained by dividing CH 13 into four). The frames 13-53 and 13-54 include the Third Primary Channel information describing at least the primary channel to be changed. Further, time information indicating until when the change of the primary channel is valid may be included. In addition, the frames 13-53 and 13-54 may serve as RTS frames in the channels CH 13 and CH 14, respectively. Note that, in a case that the CH 11-1, the CH 11, and the CH 12 are in the idle states, the frames 13-53 and 13-54 may be transmitted to the CH 11 and the CH 12, respectively. That is, the frame requesting the change of the primary channel is transmitted with the subchannel configured by the Legacy Primary Channel information or the Second Primary Channel information being used as the primary channel.

The access point apparatus 1-1 transmits frames 13-63 and 13-64 indicating whether to accept the change request specified by the station apparatus 2-3 until when. Further, time information indicating until when the change of the primary channel is valid may be included. In addition, the frames 13-63 and 13-64 may serve as CTS frames in channels CH 13 and CH 14, respectively. In a case that the frames 13-63 and 13-64 indicate that the request of the station apparatus 2-3 is accepted, the station apparatus 2-3 may configure the requested subchannel CH 13-4 as the primary channel to transmit uplink data frames 13-33 and 13-34.

The description in the previous paragraph is an example in which the second embodiment is implemented in combination with the first embodiment. The second embodiment, as compared with the first embodiment, has an advantage that each station apparatus can determine the primary channel with a high degree of freedom, although there is an overhead caused by obtaining the approval from the access point apparatus to change the primary channel. In the case that the second embodiment is implemented in combination with the first embodiment, even in a case that both the subchannel designated by the Legacy Primary Channel information and the subchannel designated by the Second Primary Channel information notified by the beacon according to the first embodiment are in the busy states, there is a possibility that the transmission right can be acquired with the subchannel requested by the Third Primary Channel information being used as the primary channel. That is, only the requesting station apparatus can temporarily change the primary channel and acquire a transmission occasion, and thus the channel utilization efficiency can be improved. Note that the second embodiment may be implemented alone without being combined with the first embodiment.

In the above description related to the first embodiment and the second embodiment, an example has been described in which the bandwidth that can be used in the radio communication system is the 320 MHz, the subchannel on the low-frequency side is the primary channel configured by the Legacy Primary Channel information, and the subchannel on the high-frequency side is the primary channel configured by the Second Primary Channel information. However, the allocation method of two primary channels is not limited to the above-described combination, and the primary channels can be freely allocated without depending on each other within the bandwidth constituting the radio communication system.

### 3. Third Embodiment

In FIG. 12 and FIG. 13 used to describe the first embodiment and the second embodiment, the subchannel designated by the Legacy Primary Channel information is used as the primary channel for downlink data frame transmission, and the subchannel designated by the Second Primary Channel information or the Third Primary Channel information is used as the primary channel for uplink data frame transmission. However, the primary channel designated by the Legacy Primary Channel information may be used for uplink data frame transmission in a certain station apparatus, and the primary channel designated by the Second Primary Channel information or the Third Primary Channel information may be used for uplink data frame transmission in another station apparatus.

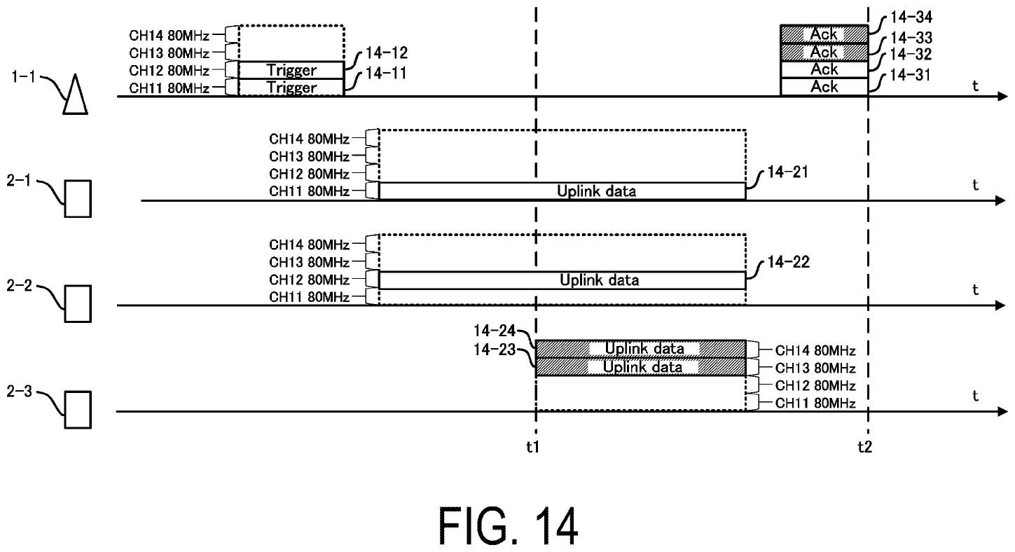

In FIG. 14, the station apparatus 2-1 transmits an uplink data frame 14-21, and the station apparatus 2-2 transmits an uplink data frame 14-22 using a channel designated by the Legacy Primary Channel information as the primary channel (for example, the subchannel CH 11-1 included in the CH 11). While the frames 14-21 and 14-22 are being transmitted, the station apparatus 2-3 cannot transmit the uplink data frames 14-23 and 14-24 using the subchannel CH 11-1 designated by the Legacy Primary Channel information as the primary channel because the subchannel CH 11-1 is in the busy state. Therefore, a subchannel (a channel other than CH 11 and CH 12, for example, the CH 14-4 included in the CH 14) designated by the Second Primary Channel information is used as the primary channel, and in a case of the idle state, the uplink data frames 14-23 and 14-24 can be transmitted.

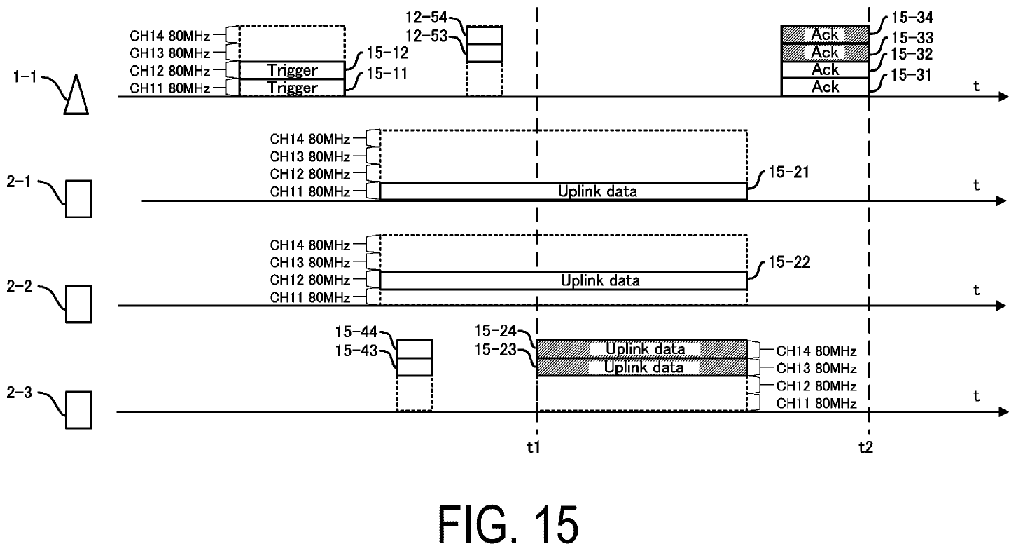

In FIG. 15, the station apparatus 2-3 transmits frames (in this example, frames 15-43 and for requesting the access point apparatus 1-1 to change the primary channel to be used by the station apparatus 2-3 for the uplink data frame transmission to the subchannel CH 13-4 included in the CH 13. The frames 15-43 and 15-44 include the Third Primary Channel information describing at least the primary channel to be changed. Further, time information indicating until when the change of the primary channel is valid may be included. In addition, the frames 15-43 and 15-44 may serve as RTS frames in the channels CH 13 and CH 14, respectively. The access point apparatus 1-1 transmits frames 15-53 and 15-54 indicating whether to accept the request for the change of the primary channel specified by the station apparatus. Further, time information indicating until when the change of the primary channel is valid may be included. In addition, the frames 15-53 and 15-54 may serve as CTS frames in the channels CH 13 and CH 14, respectively. In a case that the frames 15-53 and 15-54 indicate that the request of the station apparatus 2-3 is accepted, the station apparatus 2-3 may configure the requested CH 13-4 as the primary channel to transmit uplink data frames 15-23 and 15-24.

Specifically, in the same overlapping time zone, the uplink data frames 15-21 and 15-22 can be transmitted using the CH 11-1 as the primary channel, and the uplink data frames 15-23 and 15-24 can be transmitted using the subchannel CH 14-4 (or the CH 13-4, etc.) different from the CH 11-1 as the primary channel. Two uplink frame transmissions based on different primary channels are simultaneously enabled.

### 4. Fourth Embodiment

In the first to third embodiments, the embodiments are described in which the uplink data frame is transmitted using the subchannel designated by the Second Primary Channel information or the Third Primary Channel information as the primary channel. The subchannel designated by the Second Primary Channel information or the Third Primary Channel information may be used as the primary channel for downlink data frame transmission.

### Matters Common for All Embodiments

Although the communication apparatuses according to an aspect of the present invention can perform communication in a frequency band (frequency spectrum) that is a so-called unlicensed band that does not require permission to use from a country or a region, frequency bands usable are not limited thereto. Although permission to use a specific service is given from a country or a region, the communication apparatuses according to an aspect of the present invention can exhibit the effect that can be brought by the purpose of preventing interference between frequencies, and the like, in a frequency band called a white band that is not actually used (e.g., a frequency band that is allocated for television broadcasting but is not used depending on regions), or a shared spectrum (shared frequency band) that is expected to be shared by multiple service providers, for example.

A program that operates in the radio communication apparatus according to the present invention is a program (a program for causing a computer to function) for controlling the CPU or the like to implement the functions of the aforementioned embodiments related to the present invention. In addition, information handled by these apparatuses is temporarily accumulated in a RAM at the time of processing, is then stored in various types of ROMs and HDDs, and is read by the CPU as necessary to be corrected and written. A semiconductor medium (e.g., a ROM, a non-volatile memory card, etc.), an optical recording medium (e.g., a DVD, an MO, an MD, a CD, a BD, etc.), a magnetic recording medium (e.g., a magnetic tape, a flexible disk, etc.), and the like can be examples of recording media for storing programs. In addition to implementing the functions of the aforementioned embodiments by performing loaded programs, the functions of the present invention are implemented in processing performed in cooperation of an operating system, other application programs, and the like based on instructions of those programs.

In a case of delivering these programs to market, the programs can be stored and distributed in a portable recording medium, or transferred to a server computer connected via a network such as the Internet. In this case, the storage device serving as the server computer is also included in the present invention. A part or an entirety of the communication apparatuses in the aforementioned embodiments may be implemented as an LSI that is typically an integrated circuit. The functional blocks of the communication apparatuses may be individually implemented as chips or may be partially or completely integrated into a chip. In a case that the functional blocks are made as integrated circuits, an integrated circuit controller for controlling them is added.

The circuit integration technique is not limited to LSI, and may be realized as dedicated circuits or a multi-purpose processor. Moreover, in a case that a circuit integration technology that substitutes an LSI appears with the advance of the semiconductor technology, it is also possible to use an integrated circuit based on the technology.

Note that the invention of the present application is not limited to the above-described embodiments. The radio communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

Although the embodiments of the invention have been described in detail above with reference to the drawings, a specific configuration is not limited to the embodiments, and designs and the like that do not depart from the essential spirit of the invention also fall within the claims.

### INDUSTRIAL APPLICABILITY

The present invention can be preferably used in a communication apparatus and a communication method.

1. A station apparatus for communicating with an access point apparatus by using a radio channel including multiple subchannels, the station apparatus comprising:
a receiver configured to receive a data frame using a first subchannel as a primary channel; and
a transmitter configured to transmit a data frame using a second subchannel as a primary channel, wherein
the second subchannel is different from the first subchannel.

2. The station apparatus according to claim 1, wherein
a subchannel determined by the access point apparatus and notified on a broadcast channel is used as the second subchannel.

3. The station apparatus according to claim 1, wherein
a subchannel determined by the station apparatus is used as the second subchannel.

4. The station apparatus according to claim 1, wherein
a subchannel determined by the station apparatus is replaced, after approval from the access point apparatus is obtained, with a subchannel that is determined by the access point apparatus and notified on a broadcast channel, the subchannel replaced being used as the second subchannel.

5. The station apparatus according to claim 1, wherein
in the radio channel, the second subchannel is determined so as to be located farthest away from the first subchannel with respect to a frequency axis.

6. The station apparatus according to claim 1, wherein
in the radio channel, a subchannel with a low utilization is used as the second subchannel.

7. The station apparatus according to claim 1, wherein
while the access point apparatus is transmitting a data frame using the first subchannel as the primary channel,
the station apparatus transmits a data frame using the second subchannel as the primary channel.

8. The station apparatus according to claim 1, wherein
while the access point apparatus is receiving a data frame using the first subchannel as the primary channel,
the station apparatus transmits a data frame using the second subchannel as the primary channel.

9. An access point apparatus for communicating with a terminal apparatus by using a radio channel including multiple subchannels, the access point apparatus comprising:
a transmitter configured to transmit a data frame using a first subchannel as a primary channel; and
a receiver configured to receive a data frame using a second subchannel as a primary channel, wherein
the second subchannel is different from the first subchannel.

10. A radio communication system that uses a radio channel including multiple subchannels, the radio communication system comprising:
an access point apparatus; and
a terminal apparatus configured to communicate with the access point apparatus, wherein
downlink communication using a first subchannel as a primary channel and uplink communication using a second subchannel as a primary channel are performed, and
the second subchannel is different from the first subchannel.
